(19) United States
(12) Patent Application Publication
(10) Pub. No.: US 2022/0309569 A1
(43) Pub. Date: Sep. 29, 2022

(54) SYSTEM AND METHOD FOR EVALUATING DIGITAL SERVICE

(71) Applicant: ISKY RESEARCH PTE. LTD., Singapore (SG)

(72) Inventor: Mark Donohue, Mortimer (GB)

(21) Appl. No.: 17/212,343

(22) Filed: Mar. 25, 2021

(51) Int. Cl. G06Q 40/02

(52) U.S. Cl. CPC G06Q 40/02

(57) ABSTRACT

Disclosed is a method for evaluating a digital service. The method comprises defining one or more benchmarks for a plurality of service categories, defining at least two options for each of the one or more benchmarks, defining a weight value for each of the at least two options, receiving responses in the form of selection of one of the at least two options, calculating a weighted total value for each benchmark, determining if a particular functionality related with one of the benchmarks is available, assigning a benchmark value to each benchmark equal to the calculated weighted total value for the corresponding benchmark of the one or more benchmarks if the particular functionality is available and calculating a digital service score based on a sum of the assigned benchmark values and a sum of the weighted total value.

### TECHNICAL FIELD

The present disclosure relates generally to scoring mechanisms and more specifically, to a system and a method for evaluating a digital service.

### BACKGROUND

Digital services such as digital banking services need a scoring mechanism. The digital banking service may be scored according to customer experiences. Such a scoring mechanism may help customers in selecting one digital banking service over another digital banking service. The scoring mechanism may also assist providers of the digital banking service in gaining an insight into customer needs and knowing how much the respective digital banking service caters to customer needs. According to the score, the providers may add or remove certain functionalities in the digital banking service in order to improve customer experience.

Conventional scoring mechanisms are biased, flawed and do not provide reliable scores. Bias in the conventional scoring mechanisms make it difficult for customers to choose an appropriate digital banking service. Also, the providers may not get the correct insight into their digital banking service. Furthermore, the providers may not be able to learn about their industry and hence, they may not be able to improve their digital banking service in order to keep pace with their competitors. The lack of an efficient, unbiased scoring methodology for digital services, such as the digital banking services, makes it difficult to make meaningful improvements to the digital service as per the customer's needs.

Therefore, in light of the foregoing discussion, there exists a need to overcome the aforementioned drawbacks associated with tools for evaluating the digital service.

### SUMMARY

An object of the present disclosure is to provide a system and a method for evaluating a digital service. Another object of the present disclosure is to provide a solution that overcomes at least partially the problems encountered in the prior art.

In one aspect, an embodiment of the present disclosure provides, a method for evaluating a digital service, the method comprising:
defining one or more benchmarks for one or more of a plurality of service categories associated with the digital service, each of the one or more benchmarks related to a functionality offered by corresponding service category of the plurality of service categories from perspective of a user;
defining at least two options for each of the one or more benchmarks, with one of the at least two options to be selected as a response by a user for each of the one or more benchmarks as an indicator of importance of the functionality offered by the related benchmark of the one or more benchmarks from perspective of the said user;
defining a weight value for each of the at least two options proportional to an importance of the functionality offered by the related benchmark of the one or more benchmarks from perspective of a user;
receiving, from a plurality of users, responses in the form of selection of one of the at least two options for each of the one or more benchmarks;
calculating a weighted total value for each of the one or more benchmarks based on the received responses and the defined weight values for the at least two options thereof;
determining if a particular functionality related with one of the benchmarks of the one or more benchmarks is available in the digital service;
assigning a benchmark value to each of the one or more benchmarks equal to the calculated weighted total value for the corresponding one of the one or more benchmarks if the related particular functionality thereto is determined to be available in the digital service; and
calculating a digital service score for the digital service based on a sum of the assigned benchmark values for the one or more benchmarks and a sum of the weighted total value for the one or more benchmarks.

In one aspect, an embodiment of the present disclosure provides, a system for evaluating a digital service, the system comprising a processor configured to:
define one or more benchmarks for one or more of a plurality of service categories associated with the digital service, each of the one or more benchmarks related to a functionality offered by corresponding service category of the plurality of service categories from perspective of a user;
define at least two options for each of the one or more benchmarks, with one of the at least two options to be selected as a response by a user for each of the one or more benchmarks as an indicator of importance of the functionality offered by the related benchmark of the one or more benchmarks from perspective of the said user;
define a weight value for each of the at least two options proportional to an importance of the functionality offered by the related benchmark of the one or more benchmarks from perspective of a user;
receive, from a plurality of users, responses in the form of selection of one of the at least two options for each of the one or more benchmarks;
calculate a weighted total value for each of the one or more benchmarks based on the received responses and the defined weight values for the at least two options thereof;
determine if a particular functionality related with one of the benchmarks of the one or more benchmarks is available in the digital service;
assign a benchmark value to each of the one or more benchmarks equal to the calculated weighted total value for the corresponding one of the one or more benchmarks if the related particular functionality thereto is determined to be available in the digital service; and
calculate a digital service score for the digital service based on a sum of the assigned benchmark values for the one or more benchmarks and a sum of the weighted total value for the one or more benchmarks.

Embodiments of the present disclosure substantially eliminate or at least partially address the aforementioned problems in the prior art, and enable efficient evaluation of the digital service.

Additional aspects, advantages, features and objects of the present disclosure will be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF DRAWINGS

Embodiments of the present disclosure will now be described, by way of example only, with reference to the following diagrams wherein:

FIG. 1 is a flowchart listing steps involved in a method for evaluating a digital service, in accordance with an embodiment of the present disclosure; and

FIG. 2 is a block diagram illustration of a system for evaluating the digital service, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides, a method for evaluating a digital service, the method comprising:
defining one or more benchmarks for one or more of a plurality of service categories associated with the digital service, each of the one or more benchmarks related to a functionality offered by corresponding service category of the plurality of service categories from perspective of a user;
defining at least two options for each of the one or more benchmarks, with one of the at least two options to be selected as a response by a user for each of the one or more benchmarks as an indicator of importance of the functionality offered by the related benchmark of the one or more benchmarks from perspective of the said user;
defining a weight value for each of the at least two options proportional to an importance of the functionality offered by the related benchmark of the one or more benchmarks from perspective of a user;
receiving, from a plurality of users, responses in the form of selection of one of the at least two options for each of the one or more benchmarks;
calculating a weighted total value for each of the one or more benchmarks based on the received responses and the defined weight values for the at least two options thereof;
determining if a particular functionality related with one of the benchmarks of the one or more benchmarks is available in the digital service;
assigning a benchmark value to each of the one or more benchmarks equal to the calculated weighted total value for the corresponding one of the one or more benchmarks if the related particular functionality thereto is determined to be available in the digital service; and
calculating a digital service score for the digital service based on a sum of the assigned benchmark values for the one or more benchmarks and a sum of the weighted total value for the one or more benchmarks.

In another aspect, an embodiment of the present disclosure provides, a system for evaluating a digital service, the system comprising a processor configured to:
define one or more benchmarks for one or more of a plurality of service categories associated with the digital service, each of the one or more benchmarks related to a functionality offered by corresponding service category of the plurality of service categories from perspective of a user;
define at least two options for each of the one or more benchmarks, with one of the at least two options to be selected as a response by a user for each of the one or more benchmarks as an indicator of importance of the functionality offered by the related benchmark of the one or more benchmarks from perspective of the said user;
define a weight value for each of the at least two options proportional to an importance of the functionality offered by the related benchmark of the one or more benchmarks from perspective of a user;
receive, from a plurality of users, responses in the form of selection of one of the at least two options for each of the one or more benchmarks;
calculate a weighted total value for each of the one or more benchmarks based on the received responses and the defined weight values for the at least two options thereof;
determine if a particular functionality related with one of the benchmarks of the one or more benchmarks is available in the digital service;
assign a benchmark value to each of the one or more benchmarks equal to the calculated weighted total value for the corresponding one of the one or more benchmarks if the related particular functionality thereto is determined to be available in the digital service; and
calculate a digital service score for the digital service based on a sum of the assigned benchmark values for the one or more benchmarks and a sum of the weighted total value for the one or more benchmarks.

The present disclosure relates to a method and a system for evaluating a digital service. Herein, the digital service may refer to delivering information via platforms such as, a website or a mobile application. The digital service replaces use of paper forms while accessing information related to an organization. Hence, users may access the information at the comfort of their homes without having to go to offices of the respective service provider. For example, by using a digital banking service, users may not have to fill in paper forms or any other physical documentary requirements, and submit it at a bank for gaining an insight of their account balance, transactions and the likes. The user may simply access the information by logging into the website or the mobile application. As may be understood, the digital service may be delivered via a digital service channel. Herein, the digital service channel may be a medium, such as, but not limited to, the mobile application and the webpage, by which the digital service is provided to a plurality of users.

For explanatory purposes of the present disclosure, hereinafter, the “digital services” has been described in terms of “digital banking services”, without any limitations. However, it may be appreciated that the teachings of the present disclosure may be applied to any digital services apart from the digital banking services.

The method comprises defining one or more benchmarks for one or more of a plurality of service categories associated with the digital service. Herein, each of the one or more benchmarks relate to a functionality offered by a corresponding service category of the plurality of service categories from the perspective of a user. One or more benchmarks may relate to questions, such as, but not limited to, see account balance, access statements, see transactions, change statement delivery, block card, cancel card, order new card, virtual card, pay someone, pay a bill, payment receipt and QR codes, that are queried from user's perspective. Herein, the user may be a customer. The plurality of service categories may be the types of service categories offered by the digital service. The one or more benchmarks may be defined for the plurality of service categories. For example, in an embodiment, the plurality of service categories comprises a first service category, a second service category and a third service category. In the present example, the first service category provides account information to the user. The second service category provides information related to cards. Herein, the cards may be debit cards, credit cards, ATM cards and the likes that may be issued by the bank to the user. The third service category provides payment. The one or more benchmarks defined for the first service category may include: see account balance, access statements, see transactions and change statement delivery, each of which relate to account information. The one or more benchmarks defined for the second service category may include: block card, cancel card, order new card and virtual card, each of which relate to information related to cards. The one or more benchmarks defined for the third service category may include: pay someone, pay a bill, payment receipt and QR codes, each of which relate to payment.

The method comprises defining at least two options for each of the one or more benchmarks, with one of the at least two options to be selected as a response by a user for each of the one or more benchmarks as an indicator of importance of the functionality offered by the related benchmark of the one or more benchmarks from perspective of the said user. As discussed, one or more benchmarks may be question queried from the user. Each of the one or more benchmarks may have options such as, but not limited to, very important, important, neutral, not important and not at all important, which may indicate how important the functionality offered by the one or more benchmarks is to the user. The user may select one of the options. For example, in an embodiment, each one or more benchmarks may include five options: very important, important, neutral, not important and not at all important. The user may select ‘very important’ if the user thinks that respective benchmark has critical relevance and must be included in the digital service. The user may select ‘not important’ if the user thinks that the respective benchmark has very low relevance and may not necessarily be included in the digital service. For example, for the digital service related to the bank, the user may select ‘very important’ option for the benchmark “see account balance”, and ‘not important’ option for the benchmark “QR codes”.

The method comprises defining a weight value for each of the at least two options proportional to an importance of the functionality offered by the related benchmark of the one or more benchmarks from perspective of a user. As discussed, the at least two options may indicate how important the one or more benchmarks is to the user. In order to distinguish the importance of each of the at least two options, the weight value may be assigned to each of the at least two options. The weight values may be any numerical values. The option which indicates that the benchmark is most important may be assigned the highest weight value and the option which indicates that the benchmark is least important may be assigned the lowest weight value. For example, in an embodiment, when the one or more benchmarks may include very important, important, neutral, not important and not at all important as the options; herein, the weight value assigned to the option ‘very important’ may be ‘5’, the weight value assigned to the option ‘important’ may be ‘4’, the weight value assigned to the option ‘neutral’ may be ‘3’, the weight value assigned to the option ‘not important’ may be ‘2’ and the weight value assigned to the option ‘not at all important’ may be ‘1’.

The method comprises receiving, from a plurality of users, responses in the form of selection of one of the at least two options for each of the one or more benchmarks. The plurality of users may be a plurality of customers whose perspective may be taken into account to improve customer experience for the digital service. In order to gain perspective of the plurality of users, ‘user needs analysis survey’ may be run for the plurality of users. Each of the users may select one of the at least two options for each of the one or more benchmarks according to his/her perspective. Referring to ‘Table 1’, responses of an exemplary ‘user needs analysis survey’ is provided. Herein, the plurality of service categories comprises the first service category, the second service category and the third service category. Each service category comprises four questions. The questions equate to one or more benchmarks that could be offered by a bank. The one or more benchmarks defined for the first service category includes: see account balance, access statements, see transactions and change statement delivery each of which relate to account information. The one or more benchmarks defined for the second service category includes: block card, cancel card, order new card and virtual card each of which relate to information related to cards. The one or more benchmarks defined for the third service category includes: pay someone, pay a bill, payment receipt and QR codes each of which relate to payment. Five options are defined for each one or more benchmarks: very important having the weight value 5, important having the weight value 4, neutral having the weight value 3, not important having the weight value 2 and not important at all having the weight value 1. The plurality of users comprises thirty users. Each of the plurality of users take the ‘user needs analysis survey’ and may select at least one option for each of the one or more benchmarks in each of the service categories on scale of very important to not at all important. For example, it may be observed from the ‘Table 1’ that fifteen users have selected very important, three users have selected important, one user has selected neutral, four users have selected not important and seven users have selected not at all important for the benchmark “see account balance”.

TABLE 1

| | | Very | | | Not | Not at all | |
|---|---|---|---|---|---|---|---|
| | | important | Important | Neutral | important | important | Total |
| | Weight | 5 | 4 | 3 | 2 | 1 | |
| | value | | | | | | |
| First | See account | 15 | 3 | 1 | 4 | 7 | 30 |
| service | balance | | | | | | |
| category | Access | 2 | 8 | 5 | 10 | 5 | 30 |
| | statements | | | | | | |
| | See | 7 | 5 | 8 | 6 | 4 | 30 |
| | transactions | | | | | | |
| | Change | 2 | 6 | 15 | 6 | 1 | 30 |
| | statement | | | | | | |
| | delivery | | | | | | |
| Second | Block Card | 5 | 7 | 5 | 8 | 5 | 30 |
| service | Cancel card | 8 | 2 | 8 | 8 | 4 | 30 |
| category | Order new | 4 | 3 | 3 | 5 | 15 | 30 |
| | card | | | | | | |
| | Virtual Card | 6 | 6 | 2 | 15 | 1 | 30 |
| Third | Pay someone | 0 | 8 | 2 | 5 | 15 | 30 |
| Service | Pay a bill | 5 | 8 | 1 | 4 | 12 | 30 |
| category | Payment | 7 | 3 | 7 | 8 | 5 | 30 |
| | receipt | | | | | | |
| | QR codes | 8 | 9 | 4 | 5 | 4 | 30 |

The method comprises calculating a weighted total value for each of the one or more benchmarks based on the received responses and the defined weight values for the at least two options thereto. As discussed, each of the at least two options may be assigned the weight value. The number of users selecting a particular option for a particular benchmark may be multiplied by a respective weight value. This may be repeated for each at least two options of each one or more benchmarks and the table with weighted results may be made. Next, the weighted total value for each of the options for the particular benchmark may be calculated by summing multiplication (sum product) of the weight value with the number of users of the plurality of users that have selected the respective option. This may be repeated for each of the one or more benchmarks to calculate the weighted total value for each of the one or more benchmarks. Referring to ‘Table 2’, it may be observed that the ‘Table 2’ provides weighted total value for the ‘user needs analysis survey’ response of ‘Table 1’. For example, referring to ‘Table 1’ and ‘Table 2’, for the benchmark ‘see account balance’, the weighted total value is calculated as:

15×5+3×4+1×3+4×2+7×1=105

In a similar manner, the weighted total value for each of the one or more benchmarks is calculated. The weighted total value may help in determining how important each of the one or more benchmarks is to the plurality of users. Referring to ‘Table 2’, it may be observed that the weighted total value for the benchmark ‘see account balance’ is highest. Hence, the benchmark ‘see account balance’ may be included in the digital service for better user experience.

TABLE 2

| | | Very | | | Not | Not at all | Weighted |
|---|---|---|---|---|---|---|---|
| | | important | Important | Neutral | Important | important | Total |
| First | See account | 75 | 12 | 3 | 8 | 7 | 105 |
| service | balance | | | | | | |
| category | Access | 10 | 32 | 15 | 20 | 5 | 82 |
| | statements | | | | | | |
| | See | 35 | 20 | 24 | 12 | 4 | 95 |
| | transactions | | | | | | |
| | Change | 10 | 24 | 45 | 12 | 1 | 92 |
| | statement | | | | | | |
| | delivery | | | | | | |
| Second | Block Card | 25 | 28 | 15 | 16 | 5 | 89 |
| service | Cancel card | 40 | 8 | 24 | 16 | 4 | 92 |
| category | Order new | 20 | 12 | 9 | 10 | 15 | 66 |
| | card | | | | | | |
| | Virtual Card | 30 | 24 | 6 | 30 | 1 | 91 |
| Third | Pay someone | 0 | 32 | 6 | 10 | 15 | 63 |
| services | Pay | 25 | 32 | 3 | 8 | 12 | 80 |
| Category | a bill | | | | | | |
| | Payment | 35 | 12 | 21 | 16 | 5 | 89 |
| | receipt | | | | | | |
| | QR codes | 40 | 36 | 12 | 10 | 4 | 102 |

| | |
|---|---|
| Sum of weighted total value for one or more benchmarks of each service category | 1046 |
| Sum of weighted total value for one or more benchmarks of first service category | 374 |
| Sum of weighted total value for one or more benchmarks of second service category | 338 |
| Sum of weighted total value for one or more benchmarks of third service category | 334 |

The method comprises determining if a particular functionality related with one of the benchmarks of the one or more benchmarks is available in the digital service. Once the ‘user needs analysis survey’ responses and the total weighted value for each of the benchmarks are obtained, in order to rank the digital service, an analysis may be done to determine whether the particular functionality is available or not. Herein, questions such as, “Can I make a payment via a Bank of America?” and “Can I lock my debit card?” may be queried. In some embodiments, information scraping may be utilized. Referring to ‘Table 3’, the questions such as, “Can I see account balance for the ‘Bank A’” may be queried from the user. In case the functionality is present in the digital service, the user may select ‘Yes’. Otherwise, the user may select ‘No’.

The method further comprises assigning a benchmark value to each of the one or more benchmarks equal to the calculated weighted total value for the corresponding one of the one or more benchmarks if the related particular functionality thereto is determined to be available in the digital service. Herein, the benchmark value may be defined as the calculated weighted total value if the related particular functionality for the corresponding one of the one or more benchmarks is present and zero if the related particular functionality for the corresponding one of the one or more benchmarks is not present. For example, referring to ‘Table 3’, benchmark values for an exemplary ‘Bank A’ are provided. It may be observed from ‘Table 3’ (below) that, the user may see account balance, access statements, virtual card and payment receipt for the ‘Bank A’. However, the user may not see transactions, change statement delivery, block card, cancel card, order new card, pay someone, pay a bill and OR codes for the ‘Bank A’. In order to find benchmark values for the one or more benchmarks where the related particular functionality for the corresponding one of the one or more benchmarks is present, the weighted total value for the corresponding one or more benchmarks may be copied from ‘Table 2’. Benchmark values for the one or more benchmarks where the related particular functionality for the corresponding one of the one or more benchmarks is not present may be zero. Similarly, referring to ‘Table 3’, benchmark values for an exemplary ‘Bank B’ are provided.

TABLE 3

| | Functionality | Benchmark |
|---|---|---|
| Benchmark | available | value |
| See account balance | Yes | 105 |
| Access statements | Yes | 82 |
| See transactions | No | 0 |
| Change | No | 0 |
| statement delivery | | |
| Block card | No | 0 |
| Cancel card | No | 0 |
| Order new card | No | 0 |
| Virtual card | Yes | 91 |
| Pay someone | No | 0 |
| Pay a bill | No | 0 |
| Payment receipt | Yes | 89 |
| OR codes | No | 0 |

| | |
|---|---|
| Sum of assigned benchmark values for each of one or more | 367 |
| benchmarks for each of plurality of service categories | |
| Sum of assigned benchmark values for each of one or more | 187 |
| benchmarks for first service category | |
| Sum of assigned benchmark values for each of one or more | 91 |
| benchmarks for second service category | |
| Sum of assigned benchmark values for each of one or more | 89 |
| benchmarks for third service category | |
| Digital service score | 35.09% |
| Service category score for first service category | 50.00% |
| Service category score for second service category | 26.92% |
| Service category score for third service category | 26.65% |

TABLE 4

| | Functionality | Benchmark |
|---|---|---|
| Benchmark | available | value |
| See account balance | No | 0 |
| Access statements | No | 0 |
| See transactions | No | 0 |
| Change statement delivery | Yes | 92 |
| Block card | Yes | 89 |
| Cancel card | Yes | 92 |
| Order new card | No | 0 |
| Virtual card | No | 0 |
| Pay someone | Yes | 63 |
| Pay a bill | Yes | 80 |
| Payment receipt | Yes | 89 |
| OR codes | Yes | 102 |

| | |
|---|---|
| Sum of assigned benchmark values for each of one or more | 607 |
| benchmarks for each of plurality of service categories | |
| Sum of assigned benchmark values for each of one or more | 92 |
| benchmarks for first service categories | |
| Sum of assigned benchmark values for each of one or more | 181 |
| benchmarks for second service categories | |
| Sum of assigned benchmark values for each of one or more | 334 |
| benchmarks for third service categories | |
| Digital service score | 58.03% |
| Service category score for first service category | 24.60% |
| Service category score for second service category | 53.55% |
| Service category score for third service category | 100.00% |

The method further comprises calculating a digital service score for the digital service based on a sum of the assigned benchmark values for the one or more benchmarks and a sum of the weighted total value for the one or more benchmark. The digital service score couples the availability of functionality with the benchmark value which indicates how important the functionality is to the plurality of users. Herein, each benchmark for the one or more benchmarks may not have the benchmark value of 1, but may have benchmark value between 0 and X, where X may change depending on ‘user needs analysis survey’ outcomes. The digital service score is calculated by dividing the sum of the assigned benchmark values for the one or more benchmarks by the sum of the weighted total value for the one or more benchmark.

In an embodiment, the sum of the assigned benchmark values for the one or more benchmarks may be the summation of the assigned benchmark value for each of one or more benchmarks for each of the plurality of service categories. Referring to ‘Table 3’, sum of the assigned benchmark values for each of the one or more benchmarks for each of the plurality of service categories for ‘Bank A’ is 367 which is calculated by summing the values: 105, 82, 91 and 89. Referring to ‘Table 4’, sum of the assigned benchmark values for each of the one or more benchmarks for each of the plurality of service categories for ‘Bank B’ is 607 which is calculated by summing the values: 92, 89, 92, 63, 80, 89 and 102.

In an embodiment, the sum of the weighted total value may be the summation of the weighted total value of each of the one or more benchmarks for each service category of the plurality of service categories. For example, referring to ‘Table 2’, the sum of the weighted total value is 1046 which is calculated by summing the values: 105, 82, 95, 92, 89, 92, 66, 91, 63, 80, 89 and 102. Hence, referring to ‘Table 2’ and ‘Table 3’ in combination, the digital service score for ‘Bank A’ may be 0.3509 which is obtained by dividing 367 by 1046. Similarly, referring to ‘Table 2’ and ‘Table 4’ in combination, the digital service score for ‘Bank B’ may be 0.5803.

Optionally, the digital service score for the digital service is calculated as a percentage of the sum of the assigned benchmark values for the one or more benchmarks and the sum of the weighted total value for the one or more benchmarks. Herein, the digital service score for the digital service is calculated as the percentage, with highest possible digital service score being 100% and lowest possible digital service score being 0%. The digital service score may be thus calculated by an equation:

$$digital service score = \frac{sum of assigned benchmark values}{sum of weighted total value} \times 100$$

Referring to ‘Table 2’ and ‘Table 3’, the digital service score for the ‘Bank A’ may be 35.09% which may be calculated by assigning the sum of the assigned benchmark values as 367 and the sum of the weighted total value as 1046 in the above equation. Referring to ‘Table 4’ and ‘Table 2’, the digital service score for the ‘Bank B’ may be 58.03% which may be calculated by assigning the sum of the assigned benchmark values as 607 and the sum of the weighted total value as 1046 in the above equation.

Optionally, the method further comprises calculating a service category score for each of the plurality of service categories based on a sum of the assigned benchmark values for the defined benchmarks of a particular service category of the plurality of service categories and a sum of the weighted total value for the defined benchmarks of the said particular service category. The service category score has a similar scoring methodology to the digital service score; however, contrary to the digital service score that may provide overall score for digital service including all the service categories of the plurality of service categories, the service category score may be calculated for each of the service category of the plurality of service categories independently. The service category score may be calculated by dividing the sum of the assigned benchmark values for the defined benchmarks of the particular service category of the plurality of service categories by the sum of the weighted total value for the defined benchmarks of the said particular service category.

It may be appreciated that the sum of the assigned benchmark values for the one or more benchmarks for the particular category may be the summation of the assigned benchmark value for each of one or more benchmarks for the said particular service category of the plurality of service categories. For example, referring to ‘Table 3’, the sum of the assigned benchmark values for each of the one or more benchmarks for the first service category for ‘Bank A’ is 187, the sum of the assigned benchmark values for each of the one or more benchmarks for the second service category for ‘Bank A’ is 91 and the sum of the assigned benchmark values for each of the one or more benchmarks for the third service category for ‘Bank A’ is 89. Similarly, referring to ‘Table 4’, the sum of the assigned benchmark values for each of one or more benchmarks for the first service category for ‘Bank B’ is 92, the sum of the assigned benchmark values for each of one or more benchmarks for the second service category for ‘Bank B’ is 181 and the sum of the assigned benchmark values for each of one or more benchmarks for the third service category for ‘Bank B’ is 334.

It may be appreciated that the sum of the weighted total value for the defined benchmarks of the particular service category may be the summation of the weighted total value of each of the one or more benchmarks for the said service category. For example, referring to ‘Table 2’, the sum of the weighted total value for the first service category is 374 which may be calculated by summing the values: the values: 105, 82, 95 and 92, the sum of the weighted total value for the second service category is 338 which may be calculated by summing the values: 89, 92, 66 and 91 and the sum of the weighted total value for the third service category is 334 which may be calculated by summing the values: 63, 80, 89 and 102. As discussed, the service category score may be calculated for each of the service categories of the plurality of service categories separately. That is, the service category score for the first service category may be obtained by dividing the sum of the assigned benchmark values for the defined benchmarks of the first service category of the plurality of service categories by the sum of the weighted total value for the defined benchmarks of the first service category.

Optionally, the service category score for each of the plurality of service categories is calculated as a percentage of the sum of the assigned benchmark values for the defined benchmarks of a particular service category of the plurality of service categories and the sum of the weighted total value for the defined benchmarks of the said particular service category. Herein, the service category score for each of the plurality of service categories is calculated as the percentage which varies between highest possible service category score being 100% and lowest possible service category score being 0%. The service category score in percentage may be thus calculated by an equation

$$\frac{\begin{matrix}sum of assigned benchmark values \\ of particular service category\end{matrix}}{\begin{matrix}sum of weighted total value \\ of said particular service category\end{matrix}} \times 100$$

Referring to ‘Table 2’ and ‘Table 3’, for the ‘Bank A’, the service category score for the first service category may be 50% which may be calculated by assigning sum of the assigned benchmark values of the first service category as 187 and the sum of the weighted total value of the first service category score as 374 in the above equation. Similarly, for the ‘Bank A’, the service category score for the second service category may be 26.92% and the service category score for the third service category may be 26.65%.

Referring to ‘Table 2’ and ‘Table 4’, for the ‘Bank B’, the service category score for first service category may be 24.60% which may be calculated by assigning sum of the assigned benchmark values of the first service category as 92 and the sum of the weighted total value of the first service category score as 374 in the above equation. Similarly, for the ‘Bank B’, the service category score for the second service category may be 53.55% and the service category score for the third service category may be 100.00%.

Optionally, the method further comprises determining a rank of each of the plurality of service categories in the digital service based on the service category scores thereof. Once the service category scores are obtained for each of the plurality of service categories, the rank may be determined for each of the plurality of service categories. Herein, rank one may be determined for the service category having the highest service category score. For example, referring to ‘Table 3’, the service category score for the first service category may be 50%, the service category score for the second service category may be 26.92% and the service category score for the third service category may be 26.65% for the ‘Bank A’. Hence, for the ‘Bank A’, the first service category may be given rank one, the second service category may be given rank two and the third service category may be given rank three. Similarly, referring to ‘Table 4’, the service category score for the first service category may be 24.60%, the service category score for the second service category may be 53.55% and the service category score for the third service category may be 100% for the ‘Bank B’. Hence, for the ‘Bank B’, the third service category may be given rank one, the second service category may be given rank two and the first service category may be given rank three.

Optionally, the method further comprises, defining at least two questions for each of the one or more benchmarks for one or more of a plurality of service categories, defining a question weight value for each of the at least two questions, receiving, from a plurality of users, responses in the form of one of affirmative and negative for each of the at least two questions, calculating a question weighted total value for each of the at least two questions based on a sum of number of received responses in the affirmative for the corresponding one of the at least two questions and the defined question weight value therefor and calculating a category weighting value for each of the plurality of service categories based on a sum of the question weighted total values for the at least two questions of the corresponding service category of the plurality of service categories.

As discussed, the method may further comprise defining at least two questions for each of the one or more benchmarks for one or more of a plurality of service categories. Herein, the question may be related to the plurality of service categories. Next, depending on the questions the question weight value for each of the at least two questions may be defined. Each of the at least two questions may be queried from the plurality of users and responses in the form of one of affirmative and negative for each of the at least two questions may be received to generate data.

Referring to ‘Table 5A’ and ‘Table 5B’, questions from the same ‘user needs analysis survey’ as in ‘Table 1’ are queried from the plurality of users. Herein, thirty (30) users may be asked to respond by rating from first to third one sample question from each of the first service category, the second service category and the third service category. This is done twice, hence, there are two tables: ‘Table 5A’ and ‘Table 5B’. If the question is rated first, it is given the question weight value of three; if the question is rated second, it is given the question weight value of two; and if the question is rated third, it is given the question weight value of one.

TABLE 5A

| Question weight value | | 1 | 2 | 3 | Total |
|---|---|---|---|---|---|
| First service category | See account balance | 20 | 5 | 5 | 30 |
| Second | Block Card | 4 | 11 | 15 | 30 |
| service category | | | | | |
| Third service category | Pay Someone | 2 | 3 | 25 | 30 |

TABLE 5B

| Question weight value | | 1 | 2 | 3 | Total |
|---|---|---|---|---|---|
| First service category | Access Statements | 12 | 4 | 14 | 30 |
| Second | Cancel Card | 11 | 7 | 12 | 30 |
| service category | | | | | |
| Third service category | QR Codes | 5 | 10 | 15 | 30 |

Once the response for each of the at least two questions is received, the method may calculate the question weighted total value for each of the at least two questions based on the sum of number of received responses in the affirmative for the corresponding one of the at least two questions and the defined question weight value therefor. For example, referring to ‘Table 5A’ and ‘Table 5B’, the question weighted total value for the first service category when the first service category is rated third may be 32 which may be calculated by multiplying the sum of number of received responses which is 32 with the defined question weight value which is one for the third rate. Similarly, question weighted total value for the first service category when the first service category is rated second may be 18 which may be calculated by multiplying the sum of number of received responses which is nine with the defined question weight value which is two for the second rank. Referring to ‘Table 6’, sum of question weighted total value for each of the plurality of service categories of ‘Table 5A’ and ‘Table 5B’ is shown. The sum of question weighted total value for the first service category may be 107 which may be obtained by adding 32, 18 and 57. Similarly, the sum of question weighted total value for the second service category may be 132 and the sum of question weighted total value for the third service category may be 153.

TABLE 6

| | | | | Sum of question | Category |
|---|---|---|---|---|---|
| Question | | | | weighted | weighting |
| weight value | 1 | 2 | 3 | total value | value |
| First | 32 | 18 | 57 | 107 | 27.30% |
| service category | | | | | |
| Second | 15 | 36 | 81 | 132 | 33.67% |
| service category | | | | | |
| Third | 7 | 26 | 120 | 153 | 39.03% |
| service category | | | | | |
| | | | | 392 | 100.00% |

Next, the method may calculate the category weighting value for each of the plurality of service categories based on the sum of the question weighted total values for the at least two questions of the corresponding service category of the plurality of service categories. Herein, the category weighting value for each of the plurality of service categories may be calculated by summing the question weighted total values for the respective service category. In an embodiment, the category weighting value for each of the plurality of service categories may be found in terms of percentage which may be calculated by the following equation:

$$\frac{\begin{matrix}sum of the question weighted total values \\ for one serv ice category\end{matrix}}{\begin{matrix}sum of the question weighted total values \\ for each of the service category\end{matrix}} \times 100$$

For example, referring to ‘Table 6’, the category weighting value for the plurality of service categories are calculated. Herein, the sum of the question weighted total values for the first service category may be 107 and the sum of the question weighted total values for all the three service categories is 392. The category weighting value in percentage may be 27.30 for the first service category which may be calculated by using 107 for sum of the question weighted total values for one service category and 392 for sum of the question weighted total values for each of the service category in the above equation.

Optionally, the method further comprises calculating a category weighted digital service score for the digital service based on a sum of multiplications of the service category score and the category weighting value for each of the plurality of service categories. Contrary to the digital service score which is calculated according to the questions, the category weighted digital service score incorporates the category weighting value to the digital service score, and may be used to calculate overall score (as opposed to a category score, as the weighting sits at the category level).

Referring to ‘Table 6’ and ‘Table 7’, ‘user needs analysis survey’ results for the ‘Bank A’ and ‘Bank B’ have been reviewed to illustrate which functionality they offer. ‘Function available’ column indicates ‘Yes’ if the benchmark is available and ‘NO’ if it is not available. Herein, the category weighted digital service score may be calculated by summing multiplication (sum product) of service category score for each service category with the respective category weighting value. Referring to ‘Table 6’ and ‘Table 7’, the category weighted digital service score for the ‘Bank A’ may be 0.3311 which may be calculated as:

0.2730×0.50+0.3367×0.2692+0.3903×0.2665

Similarly, referring to ‘Table 6’ and ‘Table 8’, the category weighted digital service score for the ‘Bank B’ may be 0.6378.

Optionally, the category weighted digital service score for the digital service is calculated as a percentage of the sum of multiplications of the service category score and the category weighting value for each of the plurality of service categories. Herein, referring to ‘Table 7’ and ‘Table 8’, category weighted digital service scores such as 0.3311 for ‘Bank A’ and 0.6378 for ‘Bank B’ may be multiplied by 100. Hence, the category weighted digital service score for the ‘Bank A’ may be 33.11% and the category weighted digital service score for the ‘Bank B’ may be 63.78%.

TABLE 7

| Function available? | Value |
|---|---|
| Yes | 105 |
| Yes | 82 |
| No | 0 |
| No | 0 |
| No | 0 |
| No | 0 |
| No | 0 |
| Yes | 91 |
| No | 0 |
| No | 0 |
| Yes | 89 |
| No | 0 |
| Category weighted digital | 33.11% |
| service score | |
| Service category score for | 50.00% |
| first service category | |
| Service category score for | 26.92% |
| second service category | |
| Service category score for | 26.65% |
| third service category | |
| Digital service index | 33.33% |
| Service category index for | 50.00% |
| first service category | |
| Service category index for | 25.00% |
| second service category | |
| Service category index for | 25.00% |
| third service category | |

TABLE 8

| Function available? | Value |
|---|---|
| No | 0 |
| No | 0 |
| No | 0 |
| Yes | 92 |
| Yes | 89 |
| Yes | 92 |
| No | 0 |
| No | 0 |
| Yes | 63 |
| Yes | 80 |
| Yes | 89 |
| Yes | 102 |
| Category weighted digital | 63.78% |
| service score | |
| Service category score for first | 24.60% |
| service category | |
| Service category score for | 53.55% |
| second service category | |
| Service category score for third | 100.00% |
| service category | |
| Digital service index | 58.33% |
| Service category index for first | 25.00% |
| service category | |
| Service category index for | 50.00% |
| second service category | |
| Service category index for third | 100.00% |
| service category | |

Optionally, the method further comprises calculating a digital service index as a percentage of number of functionalities related with the one or more benchmarks available in the digital service and a total number of the one or more defined benchmarks therefor. The method may provide the digital service index in percentage, with the highest possible digital service index being 100% and lowest digital service index being 0%. The digital service index is intended to provide a view of what percentage of one or more benchmarks are offered by the provider in the digital service channel such as, but not limited to, mobile application, desktop application, tablet application, desktop web or mobile web. Herein, each one or more benchmark has a value of 1. The digital service index may be calculated by the following equation:

$$\frac{\begin{matrix}number of functionalities available \\ in digital service\end{matrix}}{\begin{matrix}total number of one or more \\ defined benchmarks\end{matrix}} \times 100$$

As discussed, in order to determine if the particular functionality related with one of the benchmarks of the one or more benchmarks is available in the digital service, questions may be queried from the user. The response of the user may then be noted down to calculate the digital service index. Referring to ‘Table 7’, the number of functionalities available in the ‘Bank A’ is four and the total number of the one or more defined benchmarks is twelve; hence, the digital service index for the ‘Bank A’ may be 33.33%. Similarly, referring to ‘Table 8’, the digital service index for the ‘Bank B’ may be calculated as 58.33%.

Optionally, the method further comprises calculating a service category index as a percentage of number of functionalities related with the one or more benchmarks available in a particular service category of the plurality of service categories and a total number of the defined benchmarks of the one or more benchmarks in the said particular service category. The service category index may have similar scoring methodology as the digital service index. However, contrary to the digital service index, the service category index may be calculated for the particular service category and not for the digital service including all the plurality of service categories at once. That is, the service category index may be calculated by the following equation:

$$\frac{\begin{matrix}number of functionalities available in \\ particular service category \times 100\end{matrix}}{\begin{matrix}total number of one or more \\ defined benchmarks in particular service category\end{matrix}}$$

For example, referring to ‘Table 7’, for the first service category, the number of functionalities available in the first category may be two and the total number of the one or more defined benchmarks in the first service category may be four. Hence, the service category index for the first category for the ‘Bank A’ may be 50%. Similarly, the service category index for the second category for the ‘Bank A’ may be 25% and the service category index for the third category for the ‘Bank A’ may be 25%.

It may be noted that the digital service index attributes an equal value to each benchmark. While the digital service index is not unique, the one or more benchmarks measured are. Coupling this information with data from the ‘user needs analysis survey’ response allows the one or more benchmarks to be weighted to become the digital service score or the category weighted digital service score, both of which may be unique and may measure how well the digital services addresses customer wants or needs, as discussed above.

Moreover, the present description also relates to a system for evaluating the digital service as described above. The various embodiments and variants disclosed above apply mutatis mutandis to the system for evaluating the digital service.

Optionally, the processor is further configured to calculate a service category score for each of the plurality of service categories based on a sum of the assigned benchmark values for the defined benchmarks of a particular service category of the plurality of service categories and a sum of the weighted total value for the defined benchmarks of the said particular service category.

Optionally, the processor is further configured to define at least two questions for each of the one or more benchmarks for one or more of a plurality of service categories, define a question weight value for each of the at least two questions, receive from a plurality of users responses in the form of one of affirmative and negative for each of the at least two questions, calculate a question weighted total value for each of the at least two questions based on a sum of number of received responses in the affirmative for the corresponding one of the at least two questions and the defined question weight value therefor and calculate a category weighting value for each of the plurality of service categories based on a sum of the question weighted total values for the at least two questions of the corresponding service category of the plurality of service categories.

Optionally, the processor is further configured to calculate a digital service index as a percentage of number of functionalities related with the one or more benchmarks available in the digital service and a total number of the one or more defined benchmarks therefor.

Optionally, the processor is further configured to calculate a service category index as a percentage of number of functionalities related with the one or more benchmarks available in a particular service category of the plurality of service categories and a total number of the defined benchmarks of the one or more benchmarks in the said particular service category.

It may be noted that the system and the method may be implemented on a cloud-based platform built in a highly scalable and modular way to calculate, filter and sort, render, categorize and compare benchmarks which may be elements of user experience. In an embodiment, the system and the method may cater for banking and insurance. In alternative embodiment, the system and the method may be used in sectors other than banking and insurance. The system and the method may be modular due to the decoupled nature of logic and data from the user interface (UI). The system and the method may be based on Amazon Web Services (AWS), for example, and all functionality may be handheld through AWS Lambda where each piece of logic or calculation is coded as a separate Lambda function. These Lambda functions may be serverless entities that allow them to scale almost infinitely. In order to compliment the scale, the system and the method uses AWS Content Delivery Network (CDN), for example, and to continue modularity at a front end, the user interface (UI) is also built as a series of standalone components such as, graphs, filters and content block that may be swapped with ease.

The system and the method are advantageous as they help in aggregation and comparison of industry vertical interfaces in a meaningful way. Moreover, the system and the method may empower providers to inform their team members, learn about their industry and compare with others. Thus, the system and the method may assist providers with strategic direction of their own business.

### DETAILED DESCRIPTION OF DRAWINGS

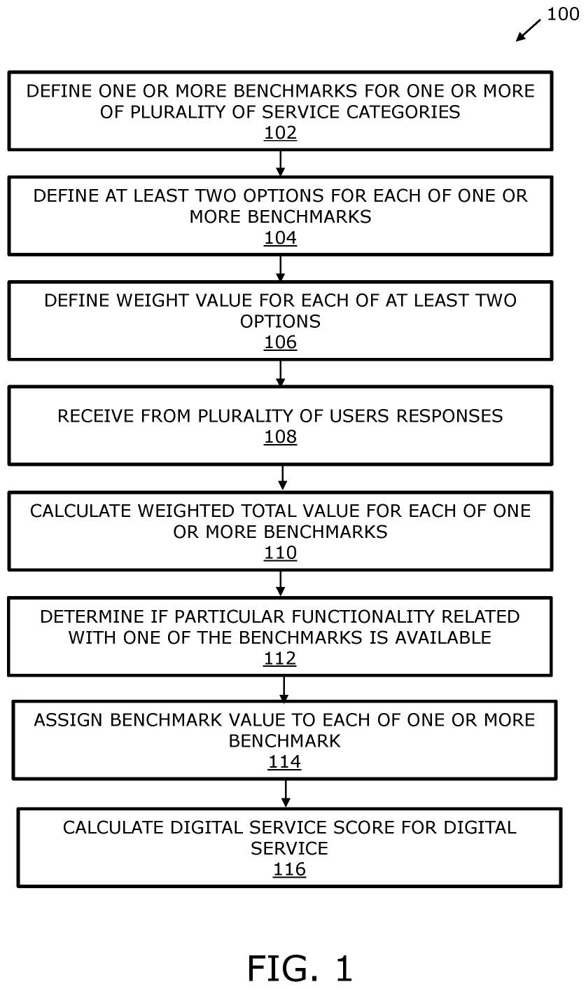

Referring to FIG. 1, there is shown a flowchart 100 listing steps involved in a method for evaluating a digital service, in accordance with an embodiment of the present disclosure. The method comprises, at step 102, defining one or more benchmarks for one or more of a plurality of service categories associated with the digital service. Herein, each of the one or more benchmarks is related to a functionality offered by the corresponding service category of the plurality of service categories from the perspective of a user. The method comprises, at step 104, defining at least two options for each of the one or more benchmarks. Herein, one of the at least two options is to be selected as a response by a user for each of the one or more benchmarks as an indicator of importance of the functionality offered by the related benchmark of the one or more benchmarks from perspective of the said user. The method comprises, at step 106, defining a weight value for each of the at least two options. Herein, the weight value for each of the at least two options is defined proportional to an importance of the functionality offered by the related benchmark of the one or more benchmarks from perspective of a user. The method comprises, at step 108, receiving, from a plurality of users, responses. Herein, the responses are received in the form of selection of one of the at least two options for each of the one or more benchmarks. The method comprises, at step 110, calculating a weighted total value for each of the one or more benchmarks. Herein, the weighted total value for each of the one or more benchmarks is calculated based on the received responses and the defined weight values for the at least two options thereof. The method comprises, at step 112, determining if a particular functionality related with one of the benchmarks of the one or more benchmarks is available in the digital service. The method comprises, at step 114, assigning a benchmark value to each of the one or more benchmarks. Herein, the assigned benchmark value is equal to the calculated weighted total value for the corresponding one of the one or more benchmarks if the related particular functionality thereto is determined to be available in the digital service. The method comprises, at step 116, calculating a digital service score for the digital service.

Herein, the digital service score for the digital service may be calculated based on a sum of the assigned benchmark values for the one or more benchmarks and a sum of the weighted total value for the one or more benchmarks.

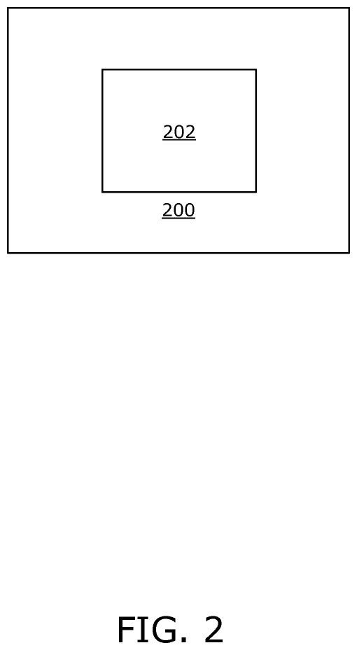

Referring to FIG. 2, there is shown a schematic illustration of a system 200 for evaluating the digital service, in accordance with an embodiment of the present disclosure. The system 200 comprises a processor 202. The processor 202 is configured to define one or more benchmarks for one or more of the pluralities of service categories associated with the digital service. Herein, each of the one or more benchmarks is related to the functionality offered by the corresponding service category of the plurality of service categories from the perspective of the user. The processor 202 is further configured to define at least two options for each of the one or more benchmarks, with one of the at least two options to be selected as the response by the user for each of the one or more benchmarks as the indicator of importance of the functionality offered by the related benchmark of the one or more benchmarks from perspective of the said user. The processor 202 is further configured to define the weight value for each of the at least two options proportional to an importance of the functionality offered by the related benchmark of the one or more benchmarks from perspective of the user. The processor 202 is further configured to receive, from the plurality of users, responses in the form of selection of one of the at least two options for each of the one or more benchmarks. The processor 202 is further configured to calculate the weighted total value for each of the one or more benchmarks based on the received responses and the defined weight values for the at least two options thereof. The processor 202 is further configured to determine if the particular functionality related with one of the benchmarks of the one or more benchmarks is available in the digital service. The processor 202 is further configured to assign the benchmark value to each of the one or more benchmarks equal to the calculated weighted total value for the corresponding one of the one or more benchmarks if the related particular functionality thereto is determined to be available in the digital service. The processor 202 is further configured to calculate a digital service score for the digital service based on the sum of the assigned benchmark values for the one or more benchmarks and the sum of the weighted total value for the one or more benchmarks.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Expressions such as “may” and “can” are used to indicate optional features, unless indicated otherwise in the foregoing. Reference to the singular is also to be construed to relate to the plural.

1. A method for evaluating a digital service, the method comprising:
defining one or more benchmarks for one or more of a plurality of service categories associated with the digital service, each of the one or more benchmarks related to a functionality offered by corresponding service category of the plurality of service categories from perspective of a user;
defining at least two options for each of the one or more benchmarks, with one of the at least two options to be selected as a response by a user for each of the one or more benchmarks as an indicator of importance of the functionality offered by the related benchmark of the one or more benchmarks from perspective of the said user;
defining a weight value for each of the at least two options proportional to an importance of the functionality offered by the related benchmark of the one or more benchmarks from perspective of a user;
receiving, from a plurality of users, responses in the form of selection of one of the at least two options for each of the one or more benchmarks;
calculating a weighted total value for each of the one or more benchmarks based on the received responses and the defined weight values for the at least two options thereof;
determining if a particular functionality related with one of the benchmarks of the one or more benchmarks is available in the digital service;
assigning a benchmark value to each of the one or more benchmarks equal to the calculated weighted total value for the corresponding one of the one or more benchmarks if the related particular functionality thereto is determined to be available in the digital service; and
calculating a digital service score for the digital service based on a sum of the assigned benchmark values for the one or more benchmarks and a sum of the weighted total value for the one or more benchmarks.

2. A method according to claim 1 further comprising calculating a service category score for each of the plurality of service categories based on a sum of the assigned benchmark values for the defined benchmarks of a particular service category of the plurality of service categories and a sum of the weighted total value for the defined benchmarks of the said particular service category.

3. A method according to claim 2 further comprising:
defining at least two questions for each of the one or more benchmarks for one or more of a plurality of service categories;
defining a question weight value for each of the at least two questions;
receiving, from a plurality of users, responses in the form of one of affirmative and negative for each of the at least two questions;
calculating a question weighted total value for each of the at least two questions based on a sum of number of received responses in the affirmative for the corresponding one of the at least two questions and the defined question weight value therefor; and
calculating a category weighting value for each of the plurality of service categories based on a sum of the question weighted total values for the at least two questions of the corresponding service category of the plurality of service categories.

4. A method according to claim 3 further comprising calculating a category weighted digital service score for the digital service based on a sum of multiplications of the service category score and the category weighting value for each of the plurality of service categories.

5. A method according to claim 1, wherein the digital service score for the digital service is calculated as a percentage of the sum of the assigned benchmark values for the one or more benchmarks and the sum of the weighted total value for the one or more benchmarks.

6. A method according to claim 2, wherein the service category score for each of the plurality of service categories is calculated as a percentage of the sum of the assigned benchmark values for the defined benchmarks of a particular service category of the plurality of service categories and the sum of the weighted total value for the defined benchmarks of the said particular service category.

7. A method according to claim 4, wherein the category weighted digital service score for the digital service is calculated as a percentage of a sum of multiplications of the service category score and the category weighting value for each of the plurality of service categories.

8. A method according to claim 1 further comprising determining a rank of each of the plurality of service categories in the digital service based on the service category scores thereof.

9. A method according to claim 1, further comprising calculating a digital service index as a percentage of number of functionalities related with the one or more benchmarks available in the digital service and a total number of the one or more defined benchmarks therefor.

10. A method according to claim 1, further comprising calculating a service category index as a percentage of number of functionalities related with the one or more benchmarks available in a particular service category of the plurality of service categories and a total number of the defined benchmarks of the one or more benchmarks in the said particular service category.

11. A system (200) for evaluating a digital service, the system comprising a processor (202) configured to:
define one or more benchmarks for one or more of a plurality of service categories associated with the digital service, each of the one or more benchmarks related to a functionality offered by corresponding service category of the plurality of service categories from perspective of a user;
define at least two options for each of the one or more benchmarks, with one of the at least two options to be selected as a response by a user for each of the one or more benchmarks as an indicator of importance of the functionality offered by the related benchmark of the one or more benchmarks from perspective of the said user;
define a weight value for each of the at least two options proportional to an importance of the functionality offered by the related benchmark of the one or more benchmarks from perspective of a user;
receive, from a plurality of users, responses in the form of selection of one of the at least two options for each of the one or more benchmarks;
calculate a weighted total value for each of the one or more benchmarks based on the received responses and the defined weight values for the at least two options thereof;
determine if a particular functionality related with one of the benchmarks of the one or more benchmarks is available in the digital service;
assign a benchmark value to each of the one or more benchmarks equal to the calculated weighted total value for the corresponding one of the one or more benchmarks if the related particular functionality thereto is determined to be available in the digital service; and
calculate a digital service score for the digital service based on a sum of the assigned benchmark values for the one or more benchmarks and a sum of the weighted total value for the one or more benchmarks.

12. A system (200) according to claim 11, wherein the processor (202) is further configured to calculate a service category score for each of the plurality of service categories based on a sum of the assigned benchmark values for the defined benchmarks of a particular service category of the plurality of service categories and a sum of the weighted total value for the defined benchmarks of the said particular service category.

13. A system (200) according to claim 12, wherein the processor (202) is further configured to:
define at least two questions for each of the one or more benchmarks for one or more of a plurality of service categories;
define a question weight value for each of the at least two questions;
receive, from a plurality of users, responses in the form of one of affirmative and negative for each of the at least two questions;
calculate a question weighted total value for each of the at least two questions based on a sum of number of received responses in the affirmative for the corresponding one of the at least two questions and the defined question weight value therefor; and
calculate a category weighting value for each of the plurality of service categories based on a sum of the question weighted total values for the at least two questions of the corresponding service category of the plurality of service categories.

14. A system (200) according to claim 10, wherein the processor (202) is further configured to calculate a digital service index as a percentage of number of functionalities related with the one or more benchmarks available in the digital service and a total number of the one or more defined benchmarks therefor.

15. A system (200) according to claim 10, wherein the processor (202) is further configured to calculate a service category index as a percentage of number of functionalities related with the one or more benchmarks available in a particular service category of the plurality of service categories and a total number of the defined benchmarks of the one or more benchmarks in the said particular service category.
